(19) United States
(12) Patent Application Publication
(10) Pub. No.: US 2006/0176341 A1
(43) Pub. Date: Aug. 10, 2006

(54) Device for dispensing drops of a liquid

(76) Inventors: Mathias Juch, Baar (CH); Marcel Aeschlimann, Ligerz (CH); Claudius Burkhardt, Luzern (CH); Bontko Witteveen, JB Venlo (NL); Antonino Lanci, Bern (CH)

Correspondence Address: Roche Diagnostics Corporation, Inc., 9115 Hague Road, PO Box 50457, Indianapolis, IN, 46250-0457, US

(21) Appl. No.: 11/287,027

(22) Filed: Nov. 23, 2005

Related U.S. Application Data
(63) Continuation of application No. PCT/CH04/00316, filed on May 24, 2004.

(30) Foreign Application Priority Data
May 28, 2003 (EP) EP 03077333.7

(51) Int. Cl. B41J 2/045

(52) U.S. Cl. 347/68

(57) ABSTRACT

A device for dispensing drops of a liquid is disclosed. The device comprises a liquid accelerating vessel (11) for receiving a volume of the liquid to be dispensed, a nozzle (14) which is directly mechanically connected with the liquid accelerating vessel (11), a bending element (15), having one portion (17) which is free to oscillate and driving means for causing bending oscillations of the bending element (15). The liquid accelerating vessel (11) has an inlet opening (12) and an outlet opening (13). The nozzle (14) has a passage (22) which is in fluid communication with the interior (21) of the liquid accelerating vessel (11). The driving means comprise a piezoelectric transducer (18) which is directly mechanically connected with the portion (17) of the bending element (15), which portion (17) is free to oscillate.

### RELATED APPLICATIONS

This application is a continuation of PCT application PCT/CH2004/000316 filed May 24, 2004 and claims priority to European application EP 03077333.7 filed May 28, 2003.

### FIELD OF THE INVENTION

The present invention is related to a device according to the pre-characterizing part of claim 1.

### BACKGROUND

U.S. Pat. No. 4,546,361 discloses a device for expelling a droplet of ink from a nozzle in a wall kept in contact with a volume of ink, so as to strike a printing medium located in face of that wall, by suddenly moving the wall towards the ink with which it is in contact. This sudden movement of the wall is effected by energizing a piezoelectric sleeve, one end of which is connected to the wall, whereas the other end of the piezoelectric sleeve is connected with a frame. When the wall is suddenly moved towards the ink, the reaction of the inertia of the ink in following the movement of the wall causes energy an ink droplet to be ejected through the nozzle at such a speed as to reach the printing medium.

European patent application EP 0 510 648 discloses a high frequency printing mechanism with an ink-jet ejection device which is capable of ejecting ink (including hot melt ink) at jet frequencies greater than 50 kHz. A cantilevered beam is mounted at its base to a piezoelectric element, which oscillates the base. The beam is shaped so that its moment of inertia is reduced toward its free end. The element is activated by an oscillating electrical signal the frequency of which is equal to or close to a natural frequency of oscillation of the beam. At this frequency of oscillation of the beam, the tip of the beam oscillates with an amplitude which is significantly greater than the oscillation amplitude of the base. The tip of the beam is provided with an aperture which is preferably tapered in cross-section. One opening of the tapered aperture is in fluid communication with a reservoir of ink and the other opening of the aperture is positioned at an appropriate distance from a printing paper towards which individual droplets of ink from the reservoir are to be propelled. When the tip amplitude is above a predetermined threshold, the solid-fluid interaction between the aperture and the ink causes a drop of ink to be accelerated through the aperture and be ejected upon each excursion of the tip of the beam toward the printing media.

In EP-0 416 540 A1, an ink jet printer recording head is disclosed in which a plurality of vibrating plates made of a piezoelectric material are fixedly spaced from a nozzle plate such that the small gap there between admits a portion of ink. The surface of each vibrating plate is integrally provided with a pair of positive and negative comb-type electrodes. By applying a voltage across these comp-type electrodes, the vibrating plates are bent toward the nozzles to press the ink and attendantly eject the ink thought the nozzles in the form of ink droplets on a recording sheet.

In WO 95/03 179, an ink-jet array for a printer is disclosed comprising an ink chamber, means for providing the ink chamber with ink, and a piezo-actuator which is rigidly secured to the ink chamber on one side. Each ink chamber can be brought into motion in response to an actuation signal in order to eject a droplet via a nozzle of the ink chamber.

### SUMMARY OF THE INVENTION

An objective of the present invention is to provide a device of the above-mentioned kind which provides one or several of the following advantages:
low cost of the device,
a device structure which makes possible to obtain oscillation of sufficient amplitude for ejecting drops of liquid with a smaller piezoelectric transducer,
high dispensing reproducibility, i.e. a coefficient of variation lower than 1% for a dispensed volume of 1 micro liter,
dispensing capability independent from the properties of the liquid being dispensed (liquids to be dispensed can thus be e.g. acids, bases, enzyme and oligo nucleotide containing solutions, saline reagents, etc.),
constant flow rate,
piezoelectric transducer is not in contact with the liquid to be dispensed,
constant response and switch off characteristics,
volume of drop dispensed in a range from 0.05 to 5 nanoliter, and
drops dispensed to receiving spot located at distance of up to several centimeters from the device.

According to the present invention this objective is achieved by means of a device defined by claim 1. Specific embodiments are defined by the subclaims.

Advantages provided by a device according to the present invention are as follows:
the low cost of the device,
the structure of the device is such that it makes possible to obtain oscillation of sufficient amplitude for ejecting drops of liquid with a smaller piezoelectric transducer,
the high reproducibility precision of the device, i.e. a coefficient of variation lower than 1% is attained for a dispensed volume of 1 micro liter,
the dispensing capability of the device is independent from the properties of the liquid being dispensed (liquids to be dispensed can thus be e.g. acids, bases, enzyme and oligo nucleotide containing solutions, saline reagents, etc.),
the constant flow rate of the device,
the piezoelectric transducer which is part of the driving means of the device is not in contact with the liquid the liquid to be dispensed,
the device has constant response and switch off characteristics,
the device allows dispensing of drops having a volume in a range from 0.05 to 5 nanoliter, and
the drops are dispensed to a receiving spot located at distance of up to several centimeters from the device.

### BRIEF DESCRIPTION OF THE DRAWINGS

The present invention will now be described in terms of several exemplified embodiments with reference to the accompanying drawings. These embodiments are set forth to aid the understanding of the invention, but are not to be construed as limiting.

FIG. 1 shows a cross-sectional view of a first embodiment of a device according to the present invention.

FIG. 2 shows an enlarged cross-sectional view of a first embodiment of liquid accelerating vessel 11 and a first embodiment of nozzle 14 in FIG. 1.

FIG. 3 shows a cross-sectional view of a single-piece element 24 which comprises both a liquid accelerating vessel and a nozzle, this element being adapted for performing the functions of liquid accelerating vessel 11 and nozzle 14 in FIG. 1.

FIG. 4 shows a cross-sectional view illustrating an intermediate step in the manufacture of a single-piece element 24 having the general shape shown in FIG. 3. This view shows this element before a bottom layer 35 thereof is perforated to form the outlet opening of the nozzle.

FIG. 5 shows a cross-sectional view of a single-piece element 24 after layer 35 shown in FIG. 4 is perforated to form the outlet opening 33 of the nozzle and the outer rim 36.

FIG. 6a shows a cross-sectional view of a second embodiment 111 of vessel 11 in FIG. 1.

FIG. 6b shows an enlarged cross-sectional view of an end portion 120 of vessel 111 in FIG. 6a.

FIG. 7 shows a cross-sectional view of a second embodiment of a device according to the present invention, wherein a liquid accelerating vessel 51 is integral part of a bending element 55.

FIG. 8 shows a cross-sectional view of a third embodiment of a device according to the present invention, wherein a liquid accelerating vessel 61 and a nozzle 64 are integral part of a bending element 65.

FIG. 9 shows a top view of a fourth embodiment of a device according to the present invention.

FIG. 10 shows a cross-sectional view of the embodiment shown by FIG. 9 along plane X-X.

FIG. 11 shows a cross-sectional view of a fifth embodiment of a device according to the present invention, wherein a bi-morph arrangement of piezoelectric transducers performs the function of a bending element 15 and is part of driving means for causing bending oscillations.

FIG. 12 shows a perspective view of a sixth embodiment of a device according to the present invention.

FIG. 13 shows a side view of the embodiment shown by FIG. 12.

FIG. 14 shows a cross-sectional view of the embodiment shown by FIG. 12.

FIG. 15 shows an enlarged cross-sectional view of the bottom portion of liquid accelerating vessel 11 and the nozzle 14 arranged in the outlet opening of vessel 11 in FIG. 12.

FIG. 16 shows a perspective view of a seventh embodiment of a device according to the present invention, wherein a fluid supply arrangement is used to keep a constant hydrostatic pressure of the liquid contained in the liquid accelerating vessel.

FIG. 17 shows a perspective view of a eighth embodiment of a device according to the present invention, wherein a fluid supply arranged in the manner of a bird bath is used to keep a constant hydrostatic pressure of the liquid contained in the liquid accelerating vessel.

FIG. 18 shows a perspective view of a liquid accelerating vessel 11 which comprises means for preventing cavitation effects.

FIG. 19 shows a cross-sectional view of the liquid accelerating vessel 11 shown by FIG. 18.

FIG. 20 shows a top view of the liquid accelerating vessel 11 shown by FIG. 18.

FIG. 21 shows a further embodiment of a liquid accelerating vessel 11 which is also suitable for minimizing cavitation effects.

FIG. 22 shows a cross-sectional view of a second embodiment of a liquid accelerating vessel 71 which is adapted for being used in the device shown by FIG. 1. The interior of this vessel is fluidically connected with a plurality of nozzle passages 75, 76, 77.

FIG. 23 shows a top view of the fourth embodiment according to FIG. 9 with a mass element 150.

FIG. 24 shows a cross-sectional view of the embodiment shown by FIG. 23 along plane X-X.

FIGS. 25 and 26 show a cross-sectional views of further embodiments of the nozzle.

FIG. 27 shows a cross-sectional view of a liquid accelerating vessel to which a negative hydrostatic pressure is applied.

FIG. 28 shows a cross-sectional view of a liquid accelerating vessel with a third section comprising a prechamber.

FIG. 29 shows a further embodiment of the present invention with a liquid accelerating vessel centrally arranged on a bending element.

### SPECIFIC EMBODIMENTS

### Example 1

### A Device According to the Present Invention

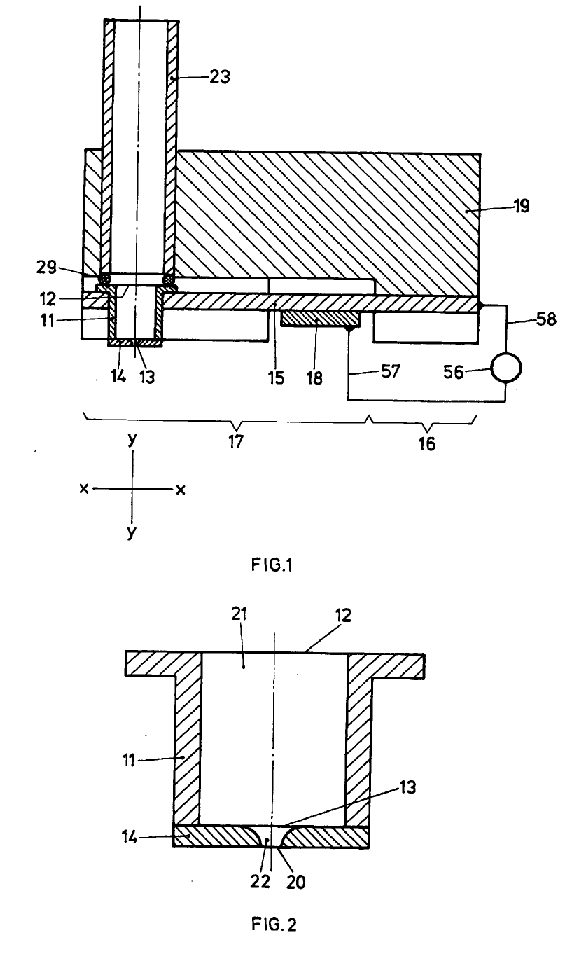

FIG. 1 shows a cross-sectional view of a first embodiment of a device according to the present invention. This device comprises a liquid accelerating vessel 11 for receiving a volume of the liquid to be dispensed, a nozzle 14 which is coupled to—e.g. directly mechanically—the liquid accelerating vessel 11, a bending element 15, e.g. a metallic, ceramic or plastic plate, having one portion 17 which is free to oscillate and driving means for causing bending oscillations of the bending element 15. The liquid accelerating vessel 11 has an inlet opening 12 and an outlet opening 13. The nozzle 14 has a passage 22 (FIG. 2) which is in fluid communication with the interior 21 of the liquid accelerating vessel 11 and an outlet orifice 20 (FIG. 2). The driving means comprise a piezoelectric transducer 18 which is directly mechanically connected with the portion 17 of the bending element 15, which portion 17 is free to oscillate. There is a rigid mechanical connection of the piezoelectric transducer 18 with the bending element 15. There is also a rigid mechanical connection of the bending element 15 with the liquid accelerating vessel 11.

In the embodiment shown in FIG. 1, the bending element 15 has a portion 16 which is mechanically coupled to a stationary body 19 and which is therefore not free to oscillate.

The piezoelectric transducer 18 and the bending element 15 are connected to a source 56 generating electrical pulses via leads 57 and 58. The electrical pulses provided by the source 56 cause contractions respectively expansions of the piezoelectric transducer 18 along an X-axis shown in FIG. 1 resulting in vibration of the portion 17 of the bending element 15 essentially along the Y-axis shown in FIG. 1.

In a rest position of the bending element 15, i.e. with no electrical pulse applied to the piezoelectric transducer 18, the X-axis is parallel to the longitudinal axis of the bending element 15. The Y-axis is normal to the X-axis.

A liquid to be dispensed is fed to the vessel 11 through a conduit 23. An O-ring seal 29 ensures that the liquid cannot leak at the joint between the conduit 23 and the vessel 11. The O-ring seal 29 allows oscillation movement of the bending element 15.

The vessel 11, the nozzle 14 and the conduit 23 have e.g. a circular cross-section.

As can be appreciated from FIG. 1, the interior of the vessel 11 is accessible through its inlet opening 12 and through its outlet opening 13.

When the driving means of the device are actuated by applying suitable electrical pulses to the piezoelectric transducer 18, the portion 17 of the bending element 15 oscillates in the direction of the Y-axis and this causes oscillation of the vessel 11. Due to this oscillation, drops are expelled out of the vessel 11 through the nozzle 14 and delivered to a receiving spot, e.g. a container located in the path of the expelled drops. By proper dimensioning of the device and of the actuation pulses applied to the piezoelectric transducer 18, the device according to the present invention allows a very accurate and reproducible dispensing of liquid, the volume of the dispensed liquid being equal to a droplet size or a multiple thereof.

In the example shown in FIG. 1, the vessel 11, the nozzle 14 and the bending element 15 are separate parts assembled together. In further embodiments, some or all of these parts are combined in one single piece part.

In the examples shown by FIGS. 1 and 2 and 7, the nozzle 14 is an exchangeable part of the device.

In the example shown by FIGS. 1 and 2, the vessel 11 and the nozzle 14 are separate parts assembled together and are also exchangeable parts of the device.

In the example shown by FIGS. 1 and 2, the vessel 11 and the bending element 15 are separate parts assembled together.

FIG. 2 shows an enlarged cross-sectional view of a first embodiment of the liquid accelerating vessel 11 and a first embodiment of the nozzle 14 in FIG. 1. As can be appreciated from FIG. 2, the nozzle 14 has a passage 22 which comprises a first section having a tapered cross-section which becomes smaller towards the outlet of the nozzle 14, a second section of substantially constant cross-section that forms the outlet of the nozzle 14, and a smooth transition from said first section to said second section.

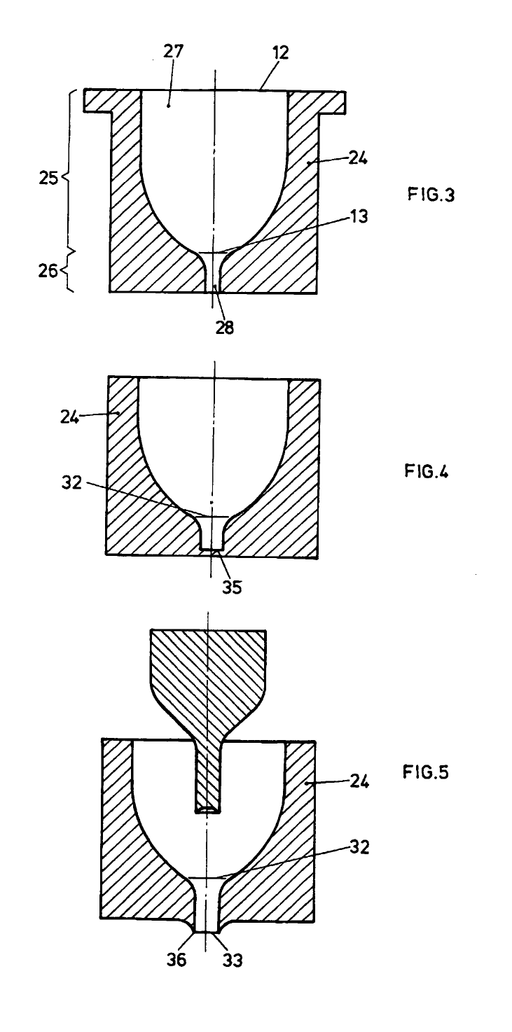

In the embodiment of the device shown by FIG. 1, the vessel 11 and the nozzle 14 are replaced by a single-piece element 24 shown by FIG. 3. The element 24 comprises both a liquid accelerating vessel and a nozzle which are integrally built. For this purpose, the single piece element 24 has a first portion 25 which serves as a liquid accelerating vessel and a second portion 26 which serves as a nozzle and includes a nozzle passage 28. The single piece element 24 is thus adapted for performing the functions of the liquid accelerating vessel 11 and the nozzle 14 depicted in FIG. 1.

In one embodiment, the cross-section of the vessel portion 25 of the single-piece element 24 shown in FIG. 3 continuously decreases from a given size at a central zone of the portion 25 towards the outlet 13 thereof, and the transition of the interior 27 of the vessel portion 25 to the passage 28 of the nozzle portion 26 of element 24 is a smooth and continuous one.

The making of a single-piece element 24 of the type shown in FIG. 3 is described with reference to FIGS. 4 and 5. FIG. 4 shows a cross-sectional view illustrating an intermediate step in the manufacture of a single-piece element 24 having the general shape shown in FIG. 3. This view shows the element 24 before a bottom layer 35 thereof is perforated to form the outlet opening of the nozzle. The nozzle portion of the single-piece element 24 has an inlet opening 32 and an outlet opening 33. The cross-section of the nozzle portion decreases from the inlet opening 32 towards the outlet opening 33 of the nozzle portion. The outlet opening 33 of the nozzle portion is initially closed by a layer 35 during manufacture of the nozzle. As represented in FIG. 5, when layer 35 is perforated to form the outlet opening 33 of the nozzle, an outer rim 36 is made that minimizes an undesirable drop formation at the outlet opening 33 of the nozzle portion of the single-piece element 24. The layer 35 is opened e.g. by ultrasonic vibration with punching force or thermal punching means.

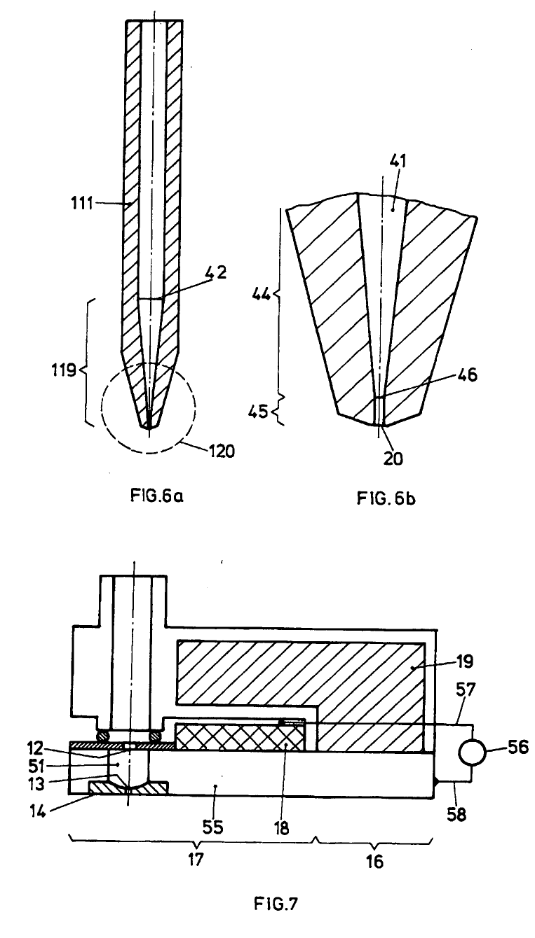

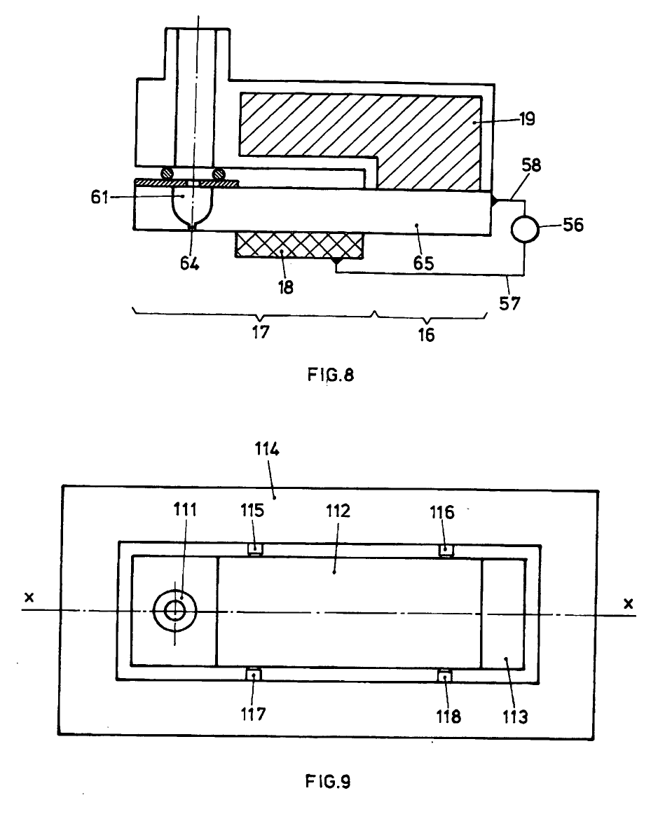

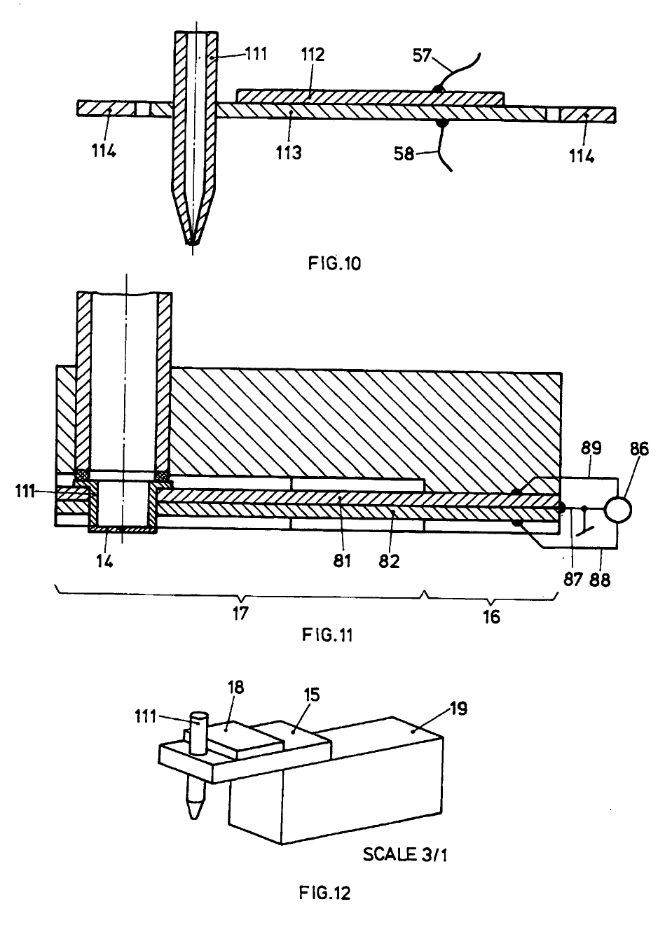

FIG. 6a shows a cross-sectional view of another embodiment 111 of liquid acceleration vessel 11 in FIG. 1. This liquid acceleration vessel 111 is suitable for the device shown in FIGS. 9 and 10, for example. An end portion of vessel 111 is a nozzle part 119. As shown by FIG. 6b which shows an enlarged view of the nozzle part 119, this nozzle has a nozzle passage 41. This passage 41 comprises a first section 44 having the shape of a funnel and cross-section which becomes smaller towards the outlet of the nozzle, a second section 45 of substantially constant cross-section forming the outlet of the nozzle, and a smooth transition 46 from said first section 44 to said second section 45. Other nozzles forming part of a device according to the present invention can have the shape of the nozzle passage just described.

### Example 2

### A Device According to the Present Invention

FIG. 7 shows a cross-sectional view of a second embodiment of a device according to the present invention. Most of the features and operation of this embodiment are the same as those described above for example 1, but a particular feature of the embodiment shown in FIG. 7 is that a liquid accelerating vessel 51 is an integral part of a bending element 55. The nozzle 14 is however a separate component which is exchangeable in a further embodiment.

### Example 3

### A Device According to the Present Invention

FIG. 8 shows a cross-sectional view of a third embodiment of a device according to the present invention. Most of the features and operation of this embodiment are the same as those described above for example 1, but a particular feature of the embodiment shown in FIG. 8 is that a liquid accelerating vessel 61 as well as a nozzle 64 are an integral part of a bending element 65.

### Example 4

### A Device According to the Present Invention

FIGS. 9 and 10 show views of a fourth embodiment of a device according to the present invention. Most of the features and operation of this embodiment are the same as those described above for example 1, but a particular feature of the embodiment shown in FIGS. 9 and 10 is that a bending element 113, e.g. an aluminum plate, has two opposite end portions which are each free to oscillate, the liquid accelerating vessel 111 is mechanically connected to bending element 113 and is located at one of the end portions thereof, and the piezoelectric transducer 112 is mechanically connected, e.g. by glue, to a third portion of bending element 113, which third portion is located between said opposite end portions. This fourth embodiment thus differs from the previous ones in that no end portion of bending element 113 is connected to a stationary body. Liquid to be dispensed is supplied to vessel 111 through its opening at its top end.

The bending element 113 and the piezoelectric transducer 112 form a bimorph structure. A frame 114, made e.g. of a plastic material, holds the latter bimorph structure at its nodes 115, 116, 117 and 118. When the piezoelectric transducer 112 is driven by suitable signals, the bimorph structure oscillates e.g. at the resonant frequency of the structure. Holding of the bimorph structure at its nodes 115, 116, 117 and 118 enables a very efficient oscillation of the structure at its resonant frequency.

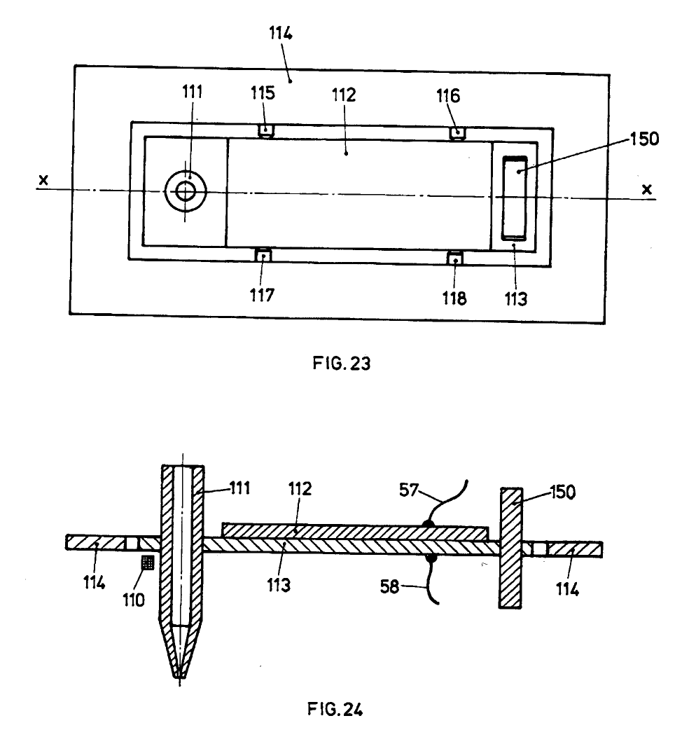

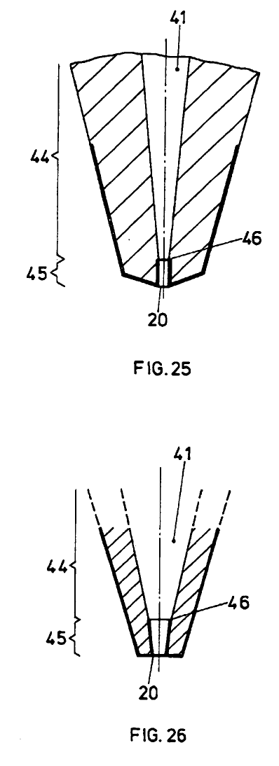

A further embodiment of the present invention is depicted in FIGS. 23 and 24 and is based on the above-described embodiment. In addition, a mass element is provided on the bending element 113 that is positioned in a loop of the oscillating bending element 113. In a more specific embodiment, as it is also depicted in FIGS. 23 and 24, the liquid accelerating vessel 111 is provided at one end portion of the bending element 113, and a mass element 150 is provided at the other end portion of the bending element 113. Therewith, amplitude amplification is obtained for the oscillation of the end portion of the bending element 113 having a lower mass. In other words, the mass element 150 is a means for adjusting amplitude amplification for a given excitation by the piezoelectric transducer 112.

In yet another embodiment of the present invention, a stop element 110 is provided on the same side of the bending element 113 as the outlet of the nozzle and at the end portion of the bending element 113 on which the accelerating vessel 111 is afixed. The stop element 110 is stationary and coupled to the frame 114, for example. The distance of the stop element 110 to the bending element 113 or another oscillating part, respectively, is such that the oscillating part stops at a desired deflection having the effect of precisely ejecting a drop out of the outlet of the nozzle. This embodiment is very well suitable—but not limited to—for liquids with a higher viscosity such as oil, for example.

### Example 5

### A Device According to the Present Invention

FIG. 11 shows a cross-sectional view of a fifth embodiment of a device according to the present invention. Most of the features and operation of this embodiment are the same as those described above for example 1, but a particular feature of the embodiment shown in FIG. 11 is that in this embodiment a bimorph arrangement of a first piezoelectric transducer 81 and a second piezoelectric transducer 82 replaces bending element 15 and piezoelectric transducer 18 attached thereto in other embodiments described above. It is expressly pointed out that the bimorph arrangement of the first and the second piezoelectric transducers 81 and 82 is not only suitable for the embodiment according to example 1 but also very well suitable for the embodiment according to example 4 in that the bending element 113 (FIGS. 9 and 10) is formed by the bimorph arrangement according to FIG. 11.

The device shown by FIG. 11 also comprises an electrical energy supply source 86 and leads 87, 88, 89 for applying the necessary actuation electrical pulses to the piezoelectric transducers 81 and 82 for causing bending oscillations of the transducers and thereby corresponding bending oscillations of the bending element they form together. The advantage of this embodiment over other embodiments described above is that the amplitude of the oscillation of the bending element, and thereby of the liquid accelerating vessel 111, is larger than when only one piezoelectric transducer is used. In addition, higher accelerations of the dispensed droplets can be obtained.

### Example 6

### A Device According to the Present Invention

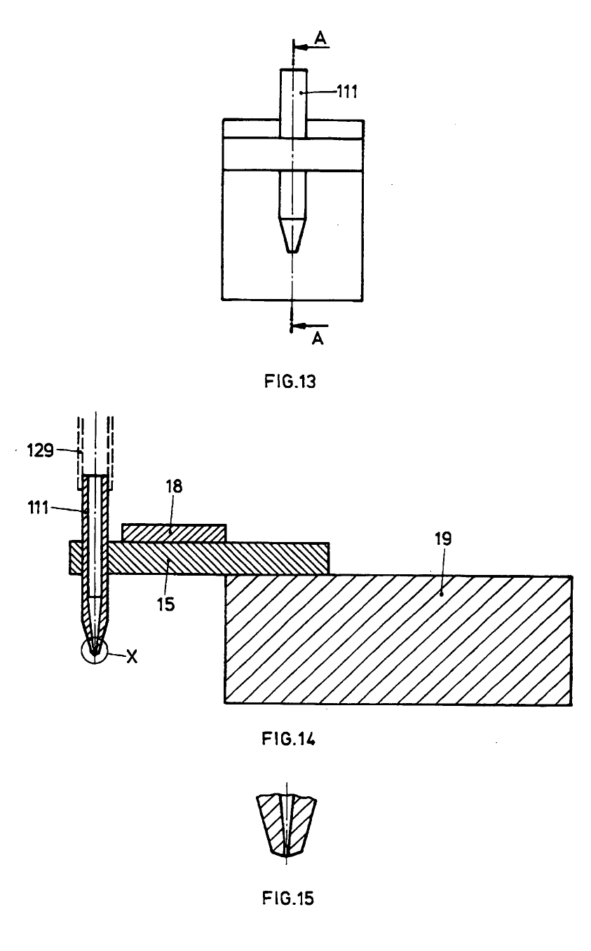

FIGS. 12 to 15 show various views of a sixth embodiment of a device according to the present invention. Most of the features and operation of this embodiment are the same as those described above for example 1, but a particular feature of the embodiment shown in FIGS. 12 to 15 is that in this embodiment the upper part of liquid accelerating vessel 111 serves as a conduit for supplying liquid to the vessel. The O-ring-seal 29 and the conduit 23 in FIG. 1 are thus not necessary in this embodiment. The top open end of the vessel 111 connects to a hose 129 made of an elastic material, e.g. a silicone hose. The hose 129 thus allows oscillation movements of the vessel 111. Liquid to be dispensed is supplied to the vessel 111 through the hose 129.

An advantageous feature of the embodiment shown in FIGS. 12 to 15 is the relative location of the stationary body 19, the piezoelectric transducer 18 and the liquid accelerating vessel 11 with respect to each other. This arrangement allows obtaining an optimal performance of the device. The electrical means necessary for actuating the piezoelectric transducer 18 are not shown in FIGS. 12 to 15.

### Example 7

### A Device According to the Present Invention

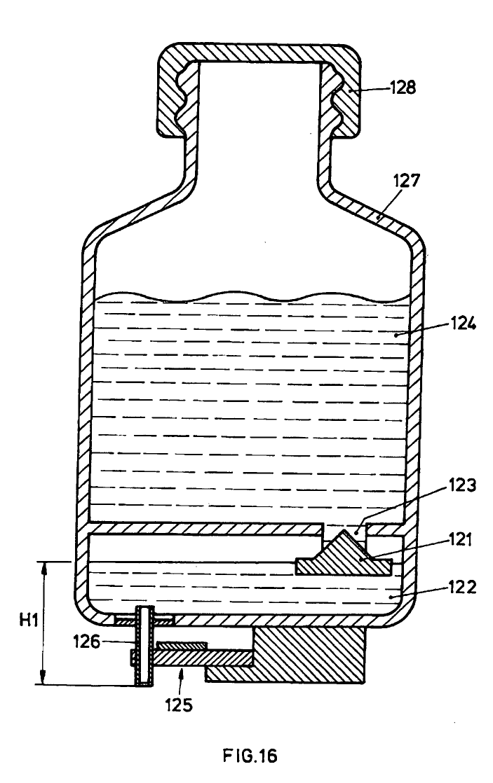

FIG. 16 shows a perspective view of a seventh embodiment of a device according to the present invention. This embodiment comprises a micro pump 125 according to the present invention, e.g. a micro pump of the type described above with reference to FIGS. 9 and 10.

The embodiment shown by FIG. 16 further comprises a fluid supply arrangement used to keep a constant predetermined hydrostatic pressure H1 of the liquid contained in the liquid accelerating vessel and thereby a constant hydrostatic pressure of the liquid supplied to the nozzle connected to that vessel. The fluid supply arrangement comprises a container 127, the top opening of which closes by a screw cap 128.

The container 127 has a bottom chamber, which contains a first volume of liquid 122 and has an opening through which that liquid is supplied to the liquid accelerating vessel 126 of the micro pump 125. The container 127 has an upper chamber, which contains a second volume of liquid 124 and has an outlet 123 through which liquid can flow from the upper chamber into the bottom chamber. A suitable nozzle is inserted or formed at the bottom end of the liquid accelerating vessel 126.

When the liquid 122 in the bottom chamber has a predetermined level, a float 121 closes the outlet 123. As liquid is dispensed by the micro pump 125, the level of liquid 122 in the bottom chamber of the container 127 sinks, the float 121 moves downwards and opens the outlet 123 of the upper chamber of the container 127. A flow of liquid from the upper chamber into the bottom chamber through outlet 123 increases the level of liquid 122, the float 121 moving upwards as a result thereof closes the outlet 123 when the latter level reaches a value corresponding to the predetermined hydrostatic pressure H1.

The screw connection between the screw cap 128 and the top opening of the container 127 ensures that air can enter into the upper chamber of the container 127.

The liquid accelerating vessel 126 of the micro pump 125 is connected to the bottom chamber of the container 127 either through a vertical channel, as shown in FIG. 16, or through a horizontal channel.

The embodiment shown by FIG. 16 further comprises a fluid supply arrangement in the manner of a birdbath. This arrangement is used to keep a constant predetermined hydrostatic pressure H1 of the liquid contained in the liquid accelerating vessel and thereby a constant hydrostatic pressure of the liquid supplied to the nozzle connected to that vessel. It is pointed out that the hydrostatic pressure H1 can be adjusted to a value, which is negative or positive in respect to the surrounding pressure. The resulting effect thereof will be further explained in connection with FIGS. 26 and 27.

A further embodiment of the present invention makes use of a hydrostatic pressure curve in which the drop size is given as a function of the hydrostatic pressure for a cartridge used for a liquid to be dispensed. With this information, the number of drops for a certain volume to be dispensed is adjustable according to a momentary hydrostatic pressure. As a result thereof, the volume of the liquid to be dispensed is independent of a momentary hydrostatic pressure. This embodiment of the present invention can very well be implemented in software running on a computer as control unit of the device according to the present invention.

### Example 8

### A Device According to the Present Invention

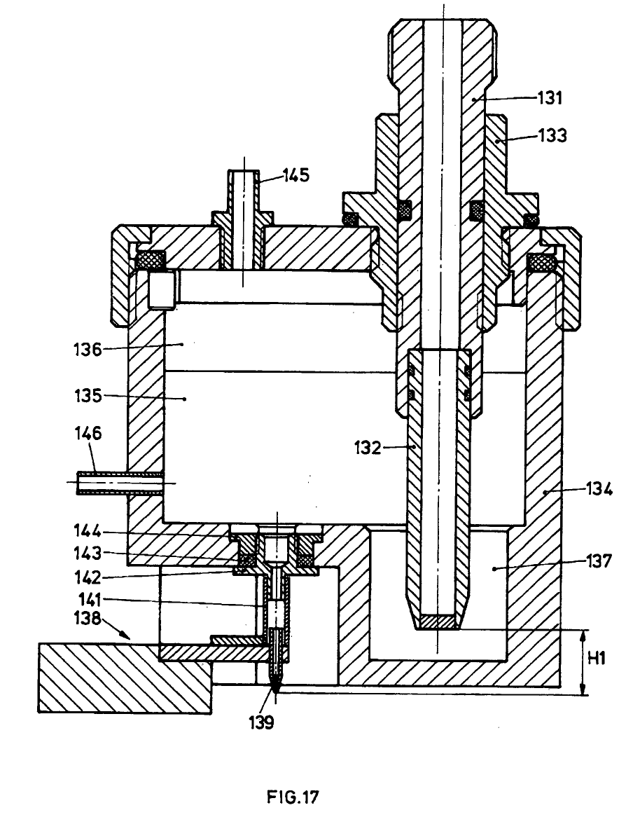

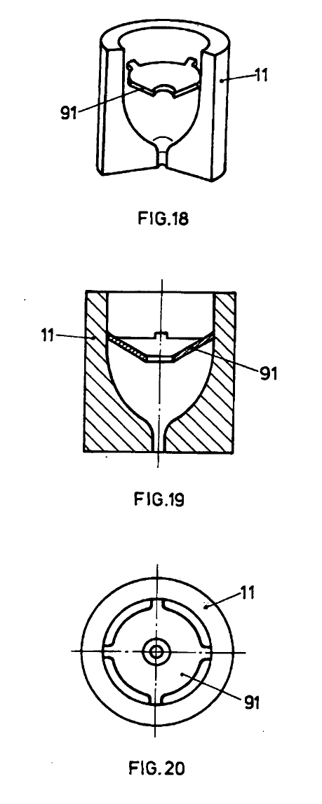

FIG. 17 shows a perspective view of an eighth embodiment of a device according to the present invention. This embodiment comprises a micro pump 138 according to the present invention, e.g. a micro pump of the type described above with reference to FIGS. 9 and 10.

The fluid supply arrangement shown by FIG. 17 comprises a container 134, which has a bottom chamber 137, which is filled with a first volume of liquid 135, and an upper chamber 136, which contains a second volume of liquid 135.

An aspiration tube having an upper section 131 and a lower section 132 is arranged as shown in FIG. 17. The position of the aspiration tube with respect to the container 134 is adjustable by means of a bushing 133, which allows a continuous adjustment of the position of the aspiration tube and thereby of the predetermined constant hydrostatic pressure H1.

The micro pump 138 is connected to the above-described liquid supply arrangement through a conduit 141 and through a sealing set comprising connecting elements 142, 144 and a sealing ring 143. The conduit 141 consists of an elastic or flexible material, which provides an airtight seal. To accomplish this, rubber or silicon is used, for example.

The arrangement shown in FIG. 17 further comprises a one-way-valve 145, which allows air aspiration for starting the operation of the birdbath arrangement.

As liquid is dispensed by the micro pump 138, the level of liquid 135 sinks, and an underpressure is thereby created in the upper chamber 136. This underpressure increases until an air bubble is aspirated through aspiration tube 131, 132.

The container 136 has a further outlet 146, which allows a more flexible adjustment of the predetermined constant hydrostatic pressure H1.

### Example 9

### Liquid Accelerating Vessels for Minimizing Cavitation Effects

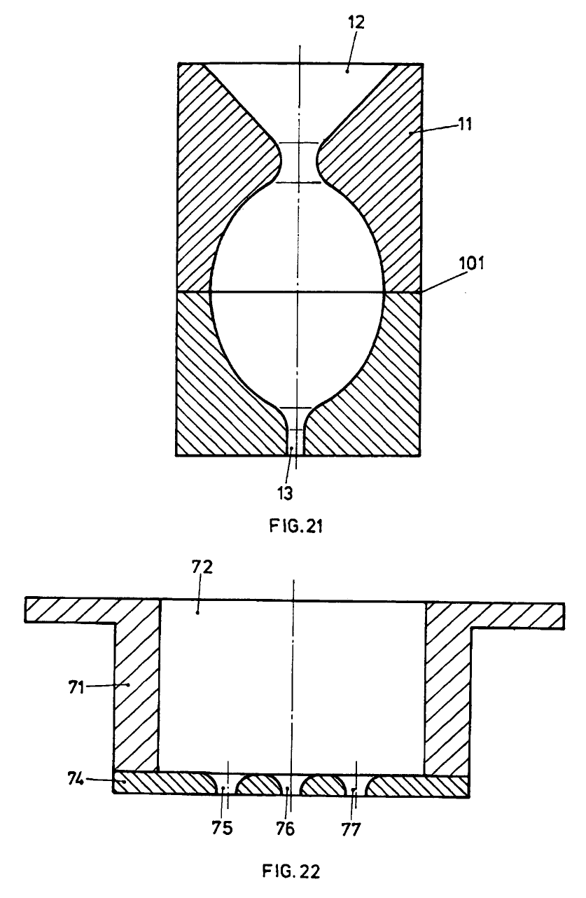

In further embodiments, a device according to the present invention comprises a liquid accelerating vessel 11 having a structure, which includes cavitation-preventing means, which prevent or at least minimize cavitation effects. Examples of such vessel structures are described hereinafter with reference to FIGS. 18 to 21.

FIGS. 18 to 20 show various views of a liquid accelerating vessel 11 having annular projections 91 which extend from the inner surface of the vessel towards the central part thereof. Annular projections 91 increase the inner surface of the lateral walls of the liquid accelerating vessel 11 and contribute thereby to prevent or at least minimize cavitation effects.

FIG. 21 shows another example of a liquid accelerating vessel 11, the inner surface of which has a shape suitable for minimizing cavitation effects. This shape is characterized in that over a portion of the liquid accelerating vessel 11 the size of the cross-section of the liquid accelerating vessel 11 has a maximum value at a plane 101 located in a central zone of that portion of the liquid accelerating vessel 11 and decreases from that maximum value towards the inlet opening 12 and towards the outlet opening 13 of the liquid accelerating vessel 11.

### Example 10

### Liquid Accelerating Vessel Connected with a Plurality of Nozzle Passages

In a still further embodiment of a device according to the present invention, the nozzle 14 has a plurality of nozzle passages. FIG. 22 shows e.g. a cross-sectional view of a variant of the vessel and the nozzle used in the device shown in FIG. 1. In this variant, the interior 72 of a liquid accelerating vessel 71 is fluidically connected with a plurality of nozzle passages 75, 76, 77 of a nozzle 74 connected to the vessel 71. The liquid accelerating vessel of all above-described device examples can be of the type shown in principle by FIG. 22.

### Example 11

### Energy Supply Means

In a still further embodiment of a device according to the present invention, the above described electrical energy supply means are adapted for selectively providing to the piezoelectric transducer or transducers electrical signals having a frequency other than the resonance frequency during desired time intervals, the application of such signals having the effect of preventing ejection of drops out of the nozzle.

In another embodiment of a device according to the present invention, the above described electrical energy supply means are adapted for selectively providing electrical signals having a predetermined frequency and voltage suitable for causing a nozzle cleaning effect during desired time intervals. For example, an application of an ultrasound frequency signal will cause the breaking of possible crystals formed of dispensable liquid at the outlet orifice of the nozzle.

Crystallization is prevented by vibrating or shaking the liquid and/or the device at another rate than is used for liquid dispensing. This vibration or shaking is, for example, provided without interruption or at a preset time interval of, for example, five minutes.

### Example 12

### Means for Monitoring the Operation of the Device

A further embodiment of a device according to the present invention further comprises means for monitoring the operation of the device. Such means are e.g. means for measuring the consumption of electrical power of the piezoelectric transducer or transducers or means for detecting flow of liquid to or out of the liquid accelerating chamber.

Other means for monitoring the operation of the device comprise capacitive sensors or photoelectric beams to implement drop counters.

### Example 13

### Manufacture of the Components of a Device According to the Present Invention

The components of a device according to the invention are made, for example, by a mass production method, e.g. by plastic injection molding, ceramic injection molding or metallic injection molding or by stamping of a plastic or metallic material.

In the examples described above,
the liquid accelerating vessel is made e.g. of a metal, plastic, ceramic, glass or a precious stone,
the nozzle is made of a metal, plastic, ceramic, glass or a precious stone, and
the bending element 15 is made of metal, ceramic, glass or plastic.

The stationary body 19 and the mass element 150 are, for example, made of metal or plastic.

In further variants of all above-described embodiments of the present invention, the inner surface of said nozzle is hydrophilic and/or the outer surface of said nozzle is hydrophobic. This surface properties are obtained e.g. by a suitable surface treatment.

In general, the bending element of a device according to the present invention oscillates at the resonant frequency of the device structure. This frequency lies, for example, in a range going from 2 to 40 kilocycles per second.

It has already been pointed out that the inner surface of the nozzle can have hydrophilic properties and/or the outer surface can have hydrophobic properties. The first property assures a defined liquid level within the nozzle between droplet generations while the latter property assures that liquid is being prevented from adhering to the outer surface of the nozzle.

For some applications, in which a liquid tending to crystallize is being used, the possibility of a choked nozzle is rather high, particularly in those applications for which rather long pauses between liquid delivering are common. The crystallization of the liquid tending to crystallize can be prevented by providing a nozzle of the type depicted in FIGS. 25 and 26. According to this aspect of the present invention—which can be used and applied independently of the other embodiments—, a hydrophobic surface is provided in at least a portion of the nozzle passage 41, for example from the outlet of nozzle orifice to the transition 46 from the first to the second section of the nozzle. In the embodiment of FIG. 25, the second section 45 has a constant cross-sectional area while in the embodiment of FIG. 26, the cross-sectional area of the second section 45 is smaller at the outlet of the nozzle orifice than the cross-sectional area of the second section 45 at the transition 46 from the first to the second section of the nozzle.

In both embodiments, the liquid will retreat to the transition 46, i.e. the position where the hydrophobic surface ends, during pauses of liquid dispensing. As a result thereof, an atmosphere of high humidity will be established in the second section 45, thereby preventing of crystallization of liquid in the area of the liquid surface. Accordingly, the nozzle will not be choked so easily as in the case of an embodiment without a hydrophobic surface in the second section 45. The establishment of a desirable atmosphere in the second section will be further favored by providing a conical second section 45. In general, this aspect of the present invention is characterized by a rather small cross-sectional area of the outlet of nozzle orifice compared to most cross-sectional areas of the second section 45.

It is pointed out that it is not mandatory that the outer surface of the nozzle comprises a hydrophobic surface. It may well be that only the inner surface of the second section 45 comprises a surface having hydrophobic properties.

In yet another embodiment of the present invention, directed to the aspect of preventing crystallization of the nozzle, a retreat of the liquid during pauses of liquid dispensing can be obtained by a negative hydrostatic pressure as defined in FIG. 16 even though no hydrophobic surface is provided at all. Therewith, a negative meniscus is obtained at the orifice of the nozzle that prevents crystallization due to the establishment of an atmosphere of high humidity in the area provided by the negative meniscus. This embodiment is illustrated by FIG. 27 in which the liquid surface at the orifice of the nozzle is indicated by a dashed line. Of course, an even better result is obtained, if the hydrophobic surface reaches into the nozzle as described along with FIG. 26.

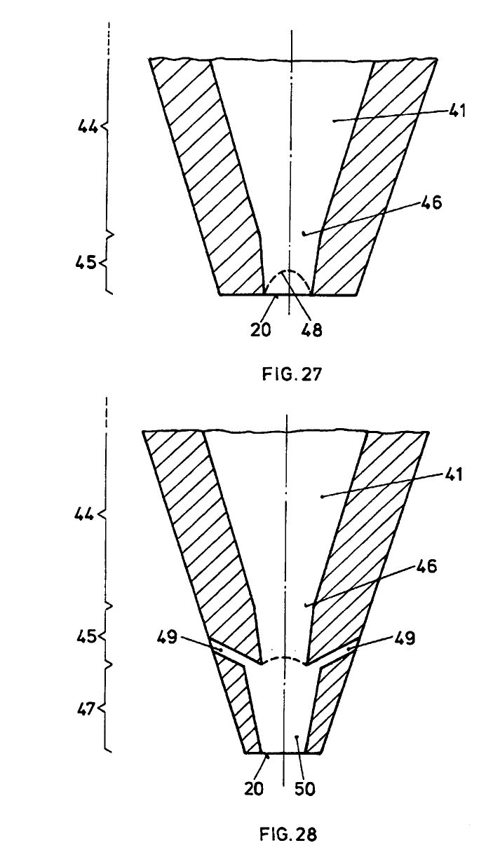

In FIG. 28, a further embodiment of the present invention, directed to the aspect of preventing crystallization and cleaning of the nozzle, is illustrated by a cross-sectional view. In addition to the first and second section 44, 45 of the nozzle, a third section 47 is provided in succession to the second section 45. The third section 47 comprises a prechamber 50 in which a saturated atmosphere is obtained as explained in connection with the embodiment according to FIG. 26. Furthermore, flush channels 49 are provided to flush the prechamber 50 or to bring in a saturated atmosphere into the prechamber 50, which results in the same effect.

The prechamber 50 and the flush channels 49 either are separate parts or form a single piece together with the first and second section 44 and 45, respectively.

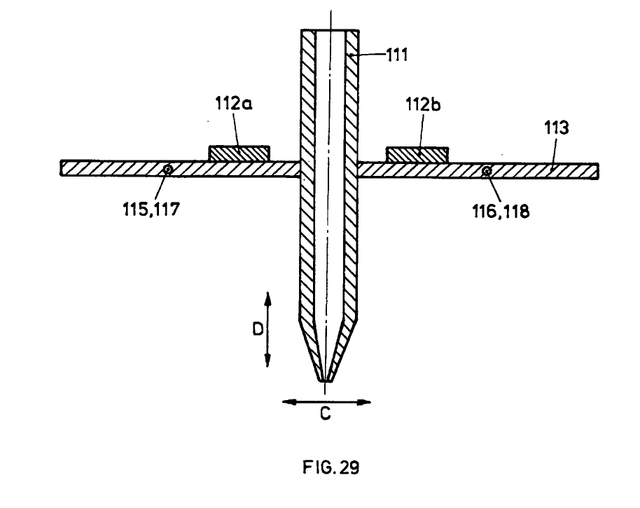

FIG. 29 shows a further embodiment of the present invention. A bending element 113 is suspended in the nodes 115, 117 and 116, 118, respectively, as it is the case for the embodiments according to FIGS. 9, 10 and 23, 24, respectively. Instead of providing a liquid accelerating vessel 11 at one of the end portions of the bending element 113, as it is the case for the embodiments according to FIG. 9, 10 and 23, 24, respectively, the liquid accelerating vessel 111 of the embodiment according to FIG. 29 is essentially at a central position of the bending element 113. Two piezoelectric transducers 112a and 112b are provided on the bending element 113 at equal distance from the liquid accelerating vessel 111. By symmetrically excitation of the piezoelectric transducers 112a and 112b, the liquid accelerating vessel 111 oscillates in direction of arrow D and liquid is dispensed accordingly. Arrow C shown in FIG. 29 indicates an oscillation which is perperdicular to arrow D and which lies in a plane in parallel to the bending element 113. For a symmetrical arrangement of the device according to the present invention, there will be no oscillation in direction of arrow C. For an asymmetrical excitation of the piezoelectric transducers 112a and 112b, the liquid accelerating vessel 111 essentially oscillates in direction of arrow C. As a result, no liquid is dispensed in this operating mode. This mode can very well be used for cleaning the nozzle or for preventing crystallization as mentioned before.

It is pointed out that for all embodiments of the present invention, an arrangement of more than one liquid accelerating vessel on a bending element or on the piezoelectric transducer, respectively, is feasible in order to increase the dispense rate for the liquid.

Although several embodiments of the present invention have been described using specific terms, such description is for illustrative purposes only, and it is to be understood that changes and variations may be made without departing from the spirit or scope of the following claims.

### Reference Numerals in Drawings

11 liquid accelerating vessel
12 inlet opening
13 outlet opening
14 nozzle
15 bending element
16 first portion of bending element
17 second portion of bending element
18 piezoelectric transducer
19 stationary body
20 outlet orifice of nozzle 14
21 interior of the liquid accelerating vessel 11
22 passage within nozzle 14
23 conduit
24 single piece element/vessel and nozzle made in one piece
25 vessel portion of single piece element 24
26 nozzle portion of single piece element 24
27 interior of vessel portion 25 of single piece element 24
28 passage in nozzle portion 26 of single piece element 24
29 O-ring seal
30
31
32 inlet opening of nozzle portion of single piece element 24
33 outlet opening of nozzle portion of single piece element 24
34
35 layer
36 outer rim of outlet opening of nozzle portion of single piece element 24
37
38
39
40
41 passage of nozzle
42 inlet of nozzle
43
44 first section of nozzle
45 second section of nozzle
46 transition from first to second section of nozzle
47 third section of nozzle
48 negative meniscus
49 flush channel
50 saturated prechamber
51 liquid accelerating vessel made as integral part of bending element 55
52
53
54
55
56 electrical energy supply
57 lead
58 lead
59
60
61 liquid accelerating vessel made as integral part of bending element 65
62
63
64 nozzle made as integral part of bending element 65
65 bending element
66
67
68
69
70
71 liquid accelerating vessel
72
73
74 nozzle
75 nozzle passage
76 nozzle passage
77 nozzle passage
78
79
80
81 first piezoelectric transducer
82 second piezoelectric transducer
83
84
85
86 electrical energy supply
87 lead
88 lead
89 lead
90
91 annular projection
92
93
94
95
96
97
98
99
100
101 plane
102
103
104
105
106
107
108
109
110 stop element
111 liquid accelerating vessel
112 piezoelectric transducer
113 bending element
114 plastic frame, stationary body
115 node
116 node
117 node
118 node
119 nozzle part of vessel 111
120 end portion of vessel 111
121 float
122 liquid
123 outlet
124 liquid
125 micropump
126 liquid accelerating vessel
127 liquid container
128 screw cap
129 hose
130
131 upper section of aspiration tube
132 lower section of aspiration tube
133 bushing
134 container
135 liquid
136 upper chamber of container 134
137 lower chamber of container 134
138 micropump
139 liquid accelerating vessel
140
141 conduit
142 connecting element
143 connecting element
144 O-ring
145 one-way-valve
146 outlet
147
148
149
150 mass element

What is claimed is:

1. A liquid dispensing apparatus comprising:
(a) a stationary portion,
(b) a bending member directly secured to the stationary portion,
(c) a liquid accelerating portion including a chamber and a nozzle having an outlet in fluid communication with the chamber, the liquid accelerating portion secured to the bending member, and
(d) a driver secured to the bending member, wherein the driver moves between an expanded position and contracted position to oscillate the bending member such that liquid is dispensed from the nozzle.

2. The liquid dispensing apparatus of claim 1, further comprising a fluid reservoir in fluid communication with the chamber of the liquid accelerating portion.

3. The liquid dispensing apparatus of claim 2, wherein the fluid reservoir maintains a constant hydrostatic pressure in the liquid accelerating portion chamber.

4. The liquid dispensing apparatus of claim 1, wherein the bending member is secured to the stationary portion in a cantilevered configuration such that the bending member has a portion in contact with the stationary portion.

5. The liquid dispensing apparatus of claim 4, wherein the driver is secured to the bending member between the liquid accelerating portion and the stationary portion.

6. The liquid dispensing apparatus of claim 5, wherein the driver comprises a piezoelectric member.

7. The liquid dispensing apparatus of claim 1, wherein the bending member is secured to the stationary portion through a plurality of pivoting connectors that form at least one pivoting axis.

8. The liquid dispensing apparatus of claim 7, wherein the plurality of connectors form two parallel pivoting axes and the liquid dispensing apparatus is secured to the bending member between the two parallel pivoting axes.

9. The liquid dispensing apparatus of claim 8, wherein the driver comprises a plurality of drivers and a first driver is secured to the bending element between the liquid accelerating portion and a first parallel pivoting axis and the second driver is secured to the bending portion between the liquid accelerating portion and a second pivoting axis.

10. The liquid dispensing apparatus of claim 9, wherein each driver is independently actuable.

11. The liquid dispensing apparatus of claim 10, wherein the drivers are selectively actuable to oscillate the bending member such that the liquid accelerating portion moves in a plurality of axes.

12. The liquid dispensing apparatus of claim 1, wherein the liquid dispensing apparatus further comprises an oscillation controller.

13. The liquid dispensing apparatus of claim 12, wherein the oscillation controller comprises a member secured to the stationary portion and positioned to physically limit the magnitude of oscillation of the bending member to a predetermined maximum magnitude.

14. The liquid dispensing apparatus of claim 12, wherein the oscillation controller comprises a mass secured to the bending member distal to the liquid accelerating portion to control the amplitude of oscillation of the bending member at the location of the liquid accelerating portion.

15. The liquid dispensing apparatus of claim 12, wherein the oscillation controller comprises an energy source coupled to the driver, the energy source providing an input to the driver to control the oscillation of the bending member.

16. The liquid dispensing apparatus of claim 1, wherein the liquid accelerating portion is integrally formed in the bending member.

17. The liquid dispensing apparatus of claim 16, wherein the chamber of liquid accelerating portion is formed in the bending member and the nozzle is removably secured to the bending member in fluid communication with the chamber of the liquid accelerating portion.

18. The liquid dispensing apparatus of claim 1, wherein the nozzle includes a passage that has a first portion with tapered diameter decreasing as the passage progresses from the liquid accelerating portion chamber and a second portion having a substantially constant diameter from the first portion to the outlet.

19. The liquid dispensing apparatus of claim 18, wherein the second portion comprises a hydrophobic material on an interior surface.

20. The liquid dispensing apparatus of claim 18, wherein the nozzle further comprises a third portion including a prechamber and flush channels configured to flush the prechamber.

21. The liquid dispensing apparatus of claim 1, wherein the nozzle comprises multiple nozzles.

22. The liquid dispensing apparatus of claim 1, wherein the fluid accelerating portion has a chamber which has a progressively decreasing diameter which transitions to the nozzle.

23. The liquid dispensing apparatus of claim 22, wherein the nozzle comprises a hydrophobic material on an interior surface.

24. The liquid dispensing apparatus of claim 22, wherein the nozzle outlet comprises an annular ring extending from the nozzle, the annular ring configured to minimize the formation of droplets at the outlet.

25. The liquid dispensing apparatus of claim 1, wherein the chamber of the liquid accelerating portion is configured to limit cavitation.

26. The liquid dispensing apparatus of claim 25, wherein the chamber includes a varying diameter passageway, the diameter progressively increasing from an inlet of the chamber to a plane of maximum diameter and progressively decreasing from the plane of maximum diameter to an outlet.

27. The liquid dispensing apparatus of claim 25, chamber having annular projections which extend inwardly from an interior wall of the chamber.

28. A liquid dispensing apparatus comprising:
(a) a stationary portion,
(b) a bending member comprising a first driver and a second driver secured to the first driver, the bending member directly secured to the stationary portion, and
(c) a liquid accelerating portion including a chamber and a nozzle having an outlet in fluid communication with the chamber, the liquid accelerating portion secured to the bending member, wherein the drivers expand and contract such that liquid is dispensed from the nozzle.

29. The liquid dispensing apparatus of claim 28, further comprising a fluid reservoir in fluid communication with the chamber of the liquid accelerating portion.

30. The liquid dispensing apparatus of claim 29, wherein the fluid reservoir maintains a constant hydrostatic pressure in the liquid accelerating portion chamber.

31. The liquid dispensing apparatus of claim 28, wherein the bending member is secured to the stationary portion in a cantilevered configuration such that the bending member has a first portion which is restricted from oscillation and a second portion which is free to oscillate and the liquid accelerating portion is secured to the second portion.

32. The liquid dispensing apparatus of claim 28, wherein a driver comprises a piezoelectric member.

33. The liquid dispensing apparatus of claim 28, wherein each driver is independently actuable.

34. The liquid dispensing apparatus of claim 33, wherein the drivers are selectively actuable to oscillate the liquid accelerating portion in a plurality of axes.

35. The liquid dispensing apparatus of claim 28, wherein the liquid dispensing apparatus further comprises a oscillation controller.

36. The liquid dispensing apparatus of claim 35, wherein the oscillation controller comprises a member secured to the stationary portion and positioned to physically limit the magnitude of oscillation of the bending member to a predetermined maximum magnitude.

37. The liquid dispensing apparatus of claim 35, wherein the nozzle includes a passage that has a first portion with tapered diameter decreasing as the passage progresses from the liquid accelerating portion chamber and a second portion having a substantially constant diameter from the first portion to the outlet.

38. The liquid dispensing apparatus of claim 37, wherein the second portion comprises a hydrophobic material on an interior surface.

39. The liquid dispensing apparatus of claim 28, wherein the nozzle comprises multiple nozzles.

40. The liquid dispensing apparatus of claim 28, wherein the fluid accelerating portion has a chamber which has a progressively decreasing diameter which transitions to the nozzle.

41. The liquid dispensing apparatus of claim 40, wherein the nozzle comprises a hydrophobic material on an interior surface.

42. The liquid dispensing apparatus of claim 41, wherein the nozzle outlet comprises an annular ring extended from the nozzle.

43. A liquid dispensing apparatus comprising:
(a) a stationary portion,
(b) a bending member secured to the stationary portion,
(c) a liquid accelerating portion including a chamber and a nozzle having an outlet in fluid communication with the chamber, the liquid accelerating portion secured to the bending member,
(d) a liquid supply apparatus including a lower chamber having an outlet in fluid communication with the chamber of the liquid accelerating portion and configured to contain a first volume of liquid, an upper chamber having an outlet in fluid communication with the lower chamber and configured to contain a second volume of liquid and a float supported on the first volume of liquid and configured to move between a first position where it substantially seals the second outlet and a second position liquid is permitted to flow from the upper chamber to the lower chamber such that when the first volume is reduced, such that when the float moves from the first position permitting liquid to exit the upper chamber reducing the second volume and increasing the first volume until the float returns to the first position restricting flow from the upper chamber thereby maintaining a substantially constant hydrostatic pressure in the chamber of the liquid accelerating portion, and
(e) a driver secured to the bending member, wherein the driver oscillates the bending member such that liquid is dispensed from the nozzle.
